(19) United States
(12) Patent Application Publication
(10) Pub. No.: US 2002/0143904 A1
(43) Pub. Date: Oct. 3, 2002

(54) Rapid network deployment

(76) Inventor: M. Zach Bair, Plano, TX (US)

Correspondence Address: HAYNES AND BOONE, LLP, 901 MAIN STREET, SUITE 3100, DALLAS, TX, 75202, US

(21) Appl. No.: 09/818,107

(22) Filed: Mar. 27, 2001

Related U.S. Application Data
(60) Provisional application No. 60/234,675, filed on Sep. 22, 2000.

(51) Int. Cl. G06F 15/16; G06F 15/177

(52) U.S. Cl. 709/220; 709/250

(57) ABSTRACT

A method and system is disclosed for automating network deployment processes using a web-centric automation toolset for one or more users. Each user has one or more customers. The toolset helps to administer one or more projects of each customer, create a site configuration for each managed project installing one ore more network devices, and complete configuration of the network devices for the managed project, wherein one or more configuration files are created by the above steps and transferred for use on the network devices.

### CROSS REFERENCE TO RELATED APPLICATION

This application claims the benefit of U.S. provisional patent application serial No. 60/234,675, filed on Sep. 22, 2000, the disclosure of which is incorporated herein by reference.

### BACKGROUND OF THE INVENTION

The present invention relates generally to configuring computer communications networks, and specifically to computer automated processes for defining, tracking, and configuring components of such networks, and generating customer and engineering documentation for the installation of the networks.

The process of defining, installing, and maintaining a communications network is becoming increasingly complex. This complexity is due, in part, to the increasing sophistication of the network's infrastructure. Many companies desire to use this increased sophistication to modify the role of their communication networks and/or to expand and automate their business operations. This complexity is also due to the fact that most communication networks are constantly changing. For example, when companies merge and/or acquire other companies, existing networks must often be combined. When companies expand, open new offices, or move to larger (or smaller) offices, new and/or different networks are often required. When new technology is installed to replace older equipment, changes to the network must be made.

What is needed is a system and method for reducing the complexities associated with defining, installing, and maintaining a communications network for a company. The system and method should also manage the company's information in an efficient manner to maintain and improve the company's business environment.

### SUMMARY OF THE INVENTION

Provided is a new and unique rapid network deployment system and method for defining, installing, and managing a communications network. In one embodiment, an Internet-based system provides rapid network deployment by managing the company's information from the point of view of one or more implementing users, referred to as “engineers.” Each engineer may have one or more clients, customers, projects, and sites. At each site, there may be one or more devices of various types. The information for these different levels of detail are entered and available for review and change.

In one example of the present invention, the system automates network deployment processes using a web-centric automation toolset for one or more engineers. Each engineer has one or more customers. The toolset helps to administer one or more projects of each customer, create a site configuration for each managed project installing one ore more network devices, and complete configuration of the network devices for the managed project, wherein one or more configuration files are created by the above steps and transferred for use on the network devices.

An engineering design and implementation specification is generated which includes general and detailed information about the client, customer, project, site(s), and device(s) involved. The specification also includes a bill of material list, a physical network diagram, a logical network diagram, and configuration files which may be loaded into the configurable devices. The system can be used to maintain customer and project information over time and can produce changes to configuration files due to the movement, change or addition of hardware to an existing communication network.

### BRIEF DESCRIPTION OF THE DRAWINGS

FIG. 1 illustrates an internet-connected computer.

FIG. 2 illustrates a rapid network deployment information hierarchy according to one example of the present invention.

FIG. 3 illustrates a flow diagram for an information structure according to one example of the present invention.

FIG. 4 illustrates a user login panel according to one example of the present invention.

FIG. 5 illustrates a system administration panel according to one example of the present invention.

FIG. 6 illustrates a client list panel according to one example of the present invention.

FIG. 7 illustrates a client information panel according to one example of the present invention.

FIG. 8 illustrates a customer list panel according to one example of the present invention.

FIG. 9 illustrates a customer information panel according to one example of the present invention.

FIG. 10 illustrates a project list panel according to one example of the present invention.

FIG. 11 illustrates a project information panel according to one example of the present invention.

FIG. 12 illustrates a site list panel according to one example of the present invention.

FIG. 13 illustrates a site information panel according to one example of the present invention.

FIG. 14 illustrates a device list panel according to one example of the present invention.

FIGS. 15-17 illustrate a device configuration panel according to one example of the present invention.

FIG. 18 illustrates a general information panel according to one example of the present invention.

FIGS. 19-20 illustrate a portion of a configuration file generated by a Rapid Network Deployment (“RND”) System according to one example of the present invention.

FIGS. 21-23 illustrate panels for editing site information according to one example of the present invention.

FIG. 24 is a logical diagram for the telecommunication device configured by the RND System according to one example of the present invention.

FIG. 25 is a physical diagram for the telecommunication device configured by the RND System according to one example of the present invention.

### DETAILED DESCRIPTION OF THE PREFERRED EMBODIMENTS

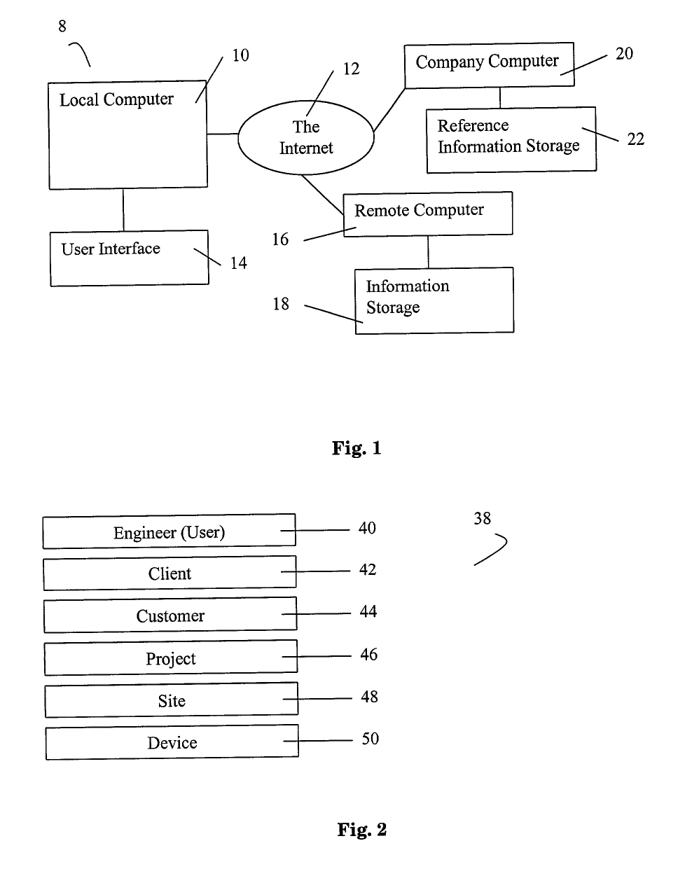

Referring now to FIG. 1, a networked computer system 8 can be used for implementing various examples of the present invention. In one embodiment, the system 8 uses the Internet 12 to connect a user of a local computer 10 to a remote computer or database servers (collectively remote computer) 18 through communications lines 17. The local computer 10 runs software which sends and receives information to and from the remote computer 16 via the Internet 12, collects information from the user via a user interface 14, and displays information to the user in the form of “web pages.” These web pages are screens of data and input slots under the control of software (typically called a “browser”) running on the local computer 10. The browsers can display pages to the user, including information the user has provided (e.g. the user's name), information from the remote computer 16, or a combination of both, along with text, graphics, audio, and video information which makes the pages attractive, useful, functional, and efficient.

The local computer 10 is connected to the Internet 12 via the communications line 17, which may include a telephone line, a local area network, a cable, and so forth. The Internet routes information between the local computer 10 and the remote computer 16. The remote computer 16 contains application-specific information (e.g., web page templates, help text, etc.), and user-related information (e.g., customer, client, project, site, device, etc.). This information is stored on appropriate information storage media 18 and is retrievable by the remote computer 16 to support the user's requests. Additionally, via the Internet, one or more company computers 20 may be accessed. These company computers contain public reference information 22, which in the present example includes a bill of material information for specific devices being configured. This bill of material information may be selected and retrieved from the company computer 20 by the user at the local computer 10.

Referring now to FIG. 2, a Rapid Network Deployment System (RND System) 38 can be illustrated as an information hierarchy according to one example of the present invention. The RND System 38 allows multiple users 40, typically called “engineers,” to utilize the local computer-remote computer combination for configuring components of the communications network. These engineers are provided user names and passwords to allow them to securely enter and maintain their own information. Each engineer may, in the course of his job, have more than one client 42. Each of these clients may be working with one or more customers 44, each having one or more projects 46, covering possibly one or more sites 48, where each site has one or more devices 50. Each engineer, client, customer, project, site, and device has its own properties and attributes which are defined by the engineer and are available for entry, review, and change by the engineer.

These entities (e.g., engineer, client, customer, project, site, and device) may be thought of as a hierarchy of dependent information where each level is defined relative to the previous level and does not exist independently. For example, each device 50 may be located at a defined site 48; each project 46 may be for a defined customer 44, etc.

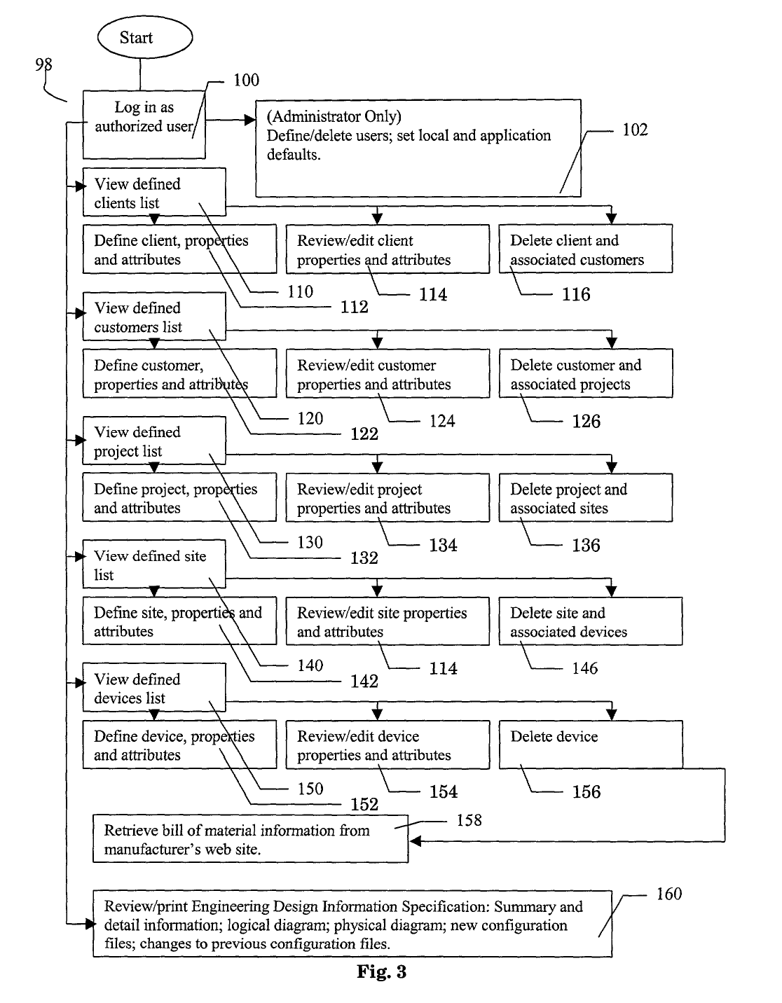

Referring further to FIG. 3, the RND System 38 can be managed by a method 98. Execution begins at step 100, when an engineer logs in as an authorized user. If the engineer is an administrator only, execution proceeds to step 102 where options are available to add or delete users, set local or application defaults, etc. Otherwise, the engineer then has the choice of working with clients at step 110, customers at step 120, projects at step 130, sites at step 140, or devices at step 150. Additionally, the engineer may review, transmit, or print the engineering design information specification at step 160.

While reviewing the list of defined clients 110, the engineer may define new clients at step 112, change the properties and attributes of previously defined clients at step 114, or delete previously defined clients at step 116. While reviewing the list of the defined customers at step 120, the engineer may define new customers at step 122, change the properties and attributes of previously defined customers at step 124, or delete previously defined customers at step 126. While reviewing the list of defined projects at step 130, the engineer may define new projects at step 132, change the properties and attributes of previously defined projects at step 134, or delete previously defined projects at step 136. While reviewing the list of defined sites at step 140, the engineer may define new sites at step 142, change the properties and attributes of previously defined sites at step 144, or delete previously defined sites at step 146. While reviewing the list of defined devices at step 150, the engineer may define new devices at step 152, change the properties and attributes of previously defined devices at step 154, or delete previously defined devices at step 156. The engineer may also retrieve device-specific bill of material information from the device manufacturer's Internet web site.

The engineering design information specification is reviewed or printed at step 160, which includes summary and detailed information for one or more sites, a logical diagram, a physical diagram, configuration files for new devices, and changed configuration files for previously defined devices affected by the addition of new devices. The configuration files may be carried, transmitted, or otherwise copied to an appropriate medium for installation at the device.

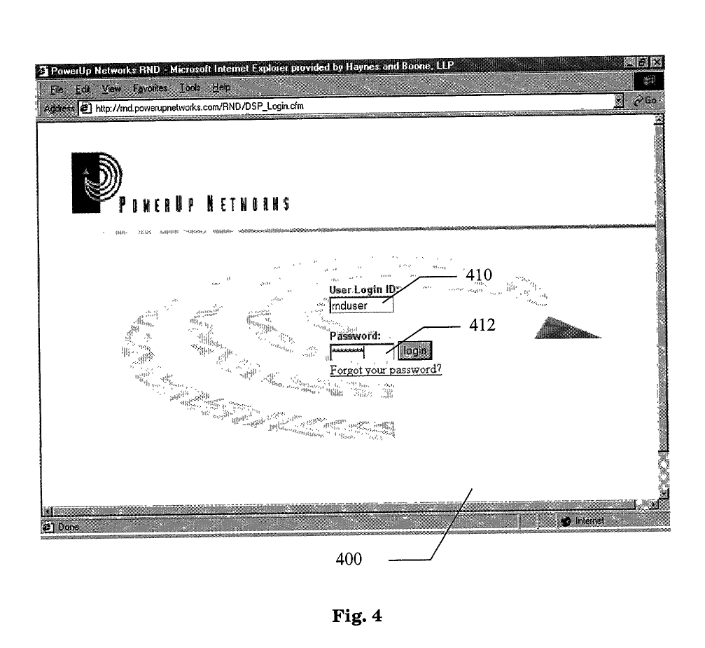

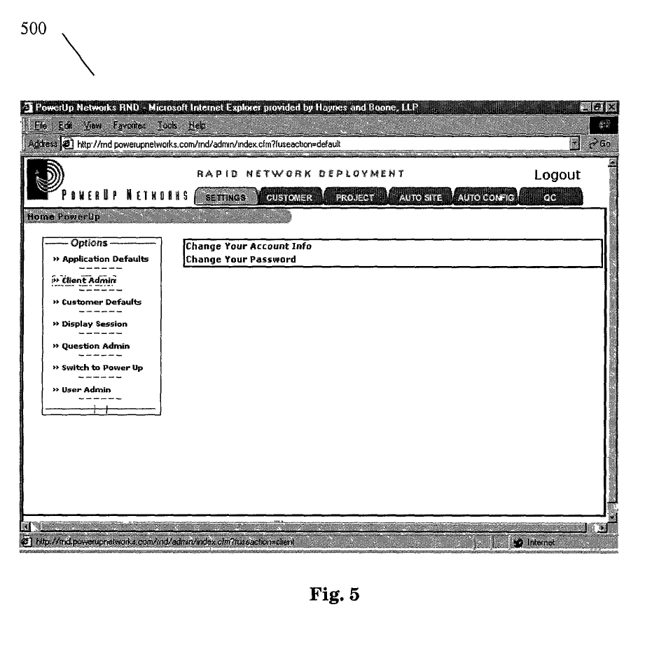

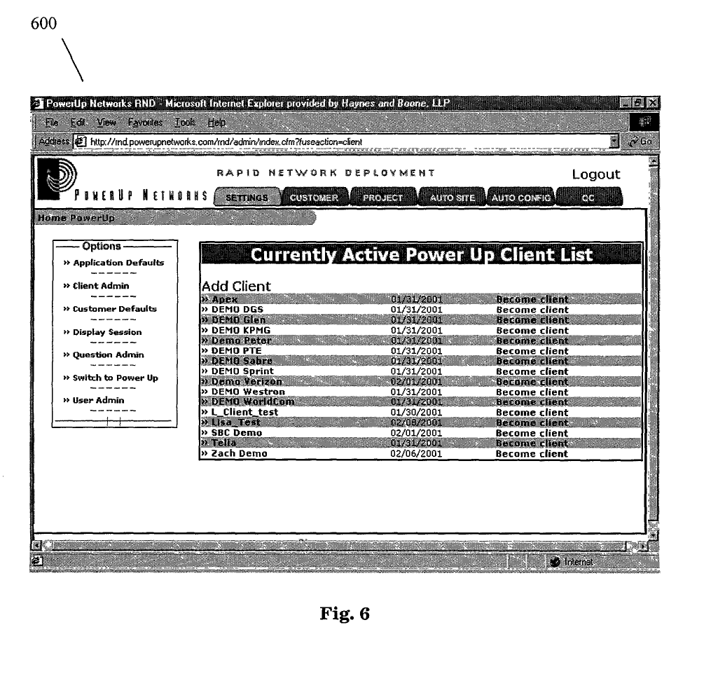

Referring now to FIGS. 4 and 5, each admitted user will be assigned with a user name and a password. With the assigned login name and password, an admitted user (engineer) can log onto any local computer and access the information stored by the RND System, which may be at a remote computer location. The engineer will see a login screen 400, and provide user name 410 and password 412. When accepted, the engineer will be logged in and will be permitted to access the RND information. Once logged in, the admitted engineer would be able to change various attributes of the setup information such as account information and the password, as shown by a settings screen 500. If the logged in engineer is authorized, the admitted engineer would also be able to perform various administrative tasks, such as setting system-wide parameters and authorizing engineers.

Referring to FIG. 6, the engineer is presented with a list of currently defined clients at a client list panel 600. If no clients have been defined, the list is presented as empty. The engineer may, at his will, add new clients, or review, change, or delete existing clients. When adding a new client, properties and attributes are added, for example, phone and address information. All defined information may be reviewed or changed. Similarly, such a client record may be deleted altogether by the engineer.

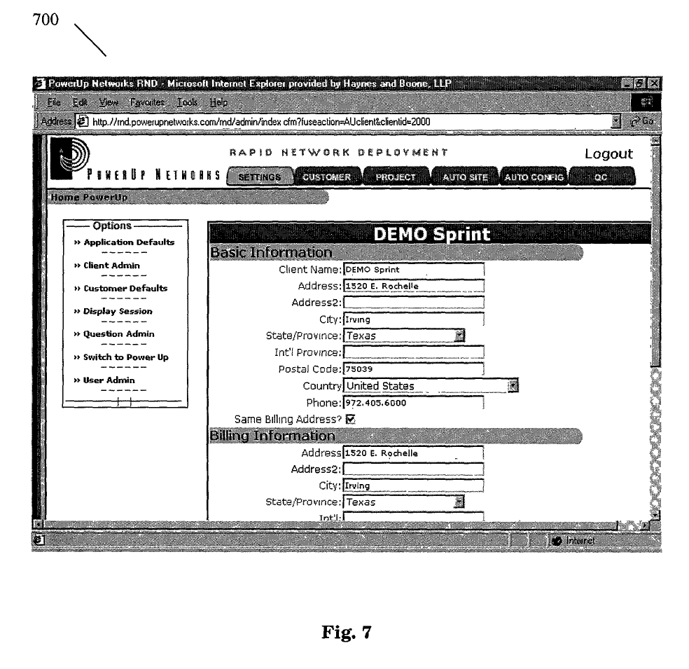

Referring to FIG. 7, a detailed client information panel 700 presents information of a client listed or to be listed in the client list shown in FIG. 6. The engineer can use the panel 700 to define one or more customers related to each client. The engineer may define new customers, or review, change or delete previously defined customers.

Similarly, for each of the levels of Project, Site, and Device, the engineer may see a list of previously defined entities. The engineer may delete a previously defined entity, may define a new entity, or may review or change the properties and attributes of a previously defined entity.

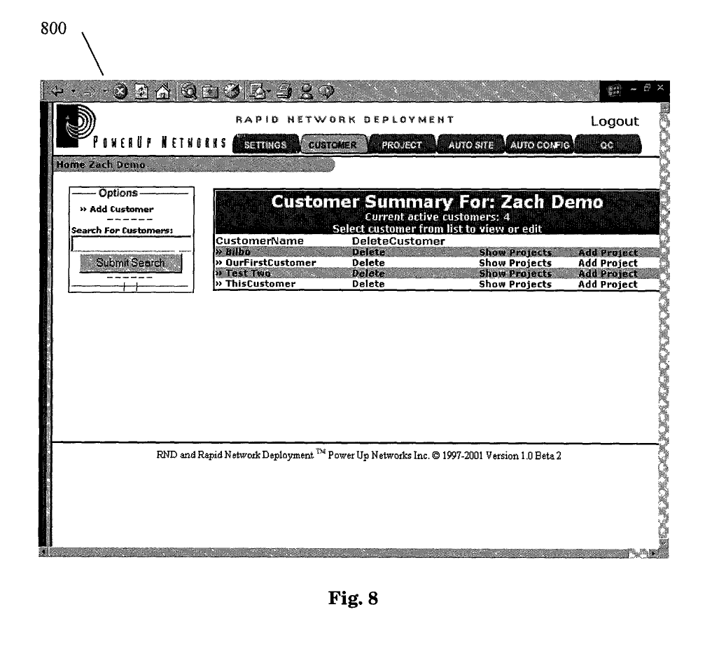

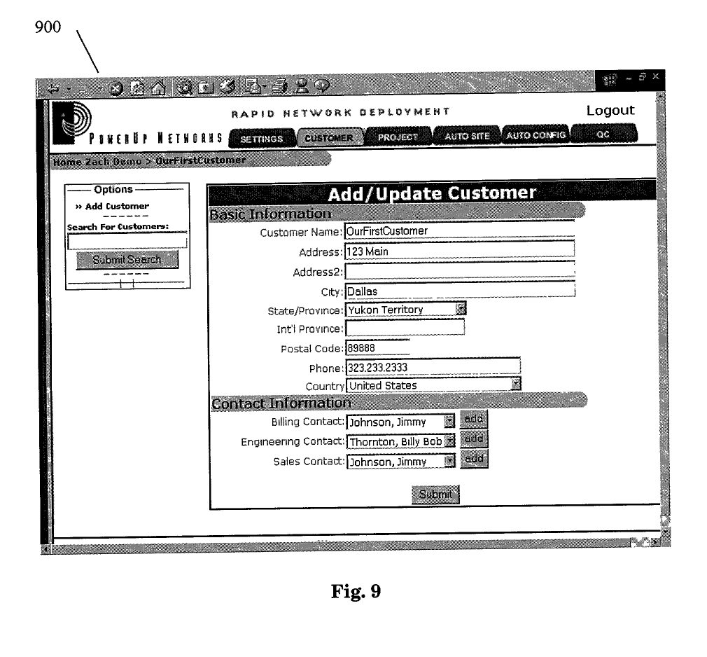

Referring to FIGS. 8 and 9, a customer list panel 800 and a customer information panel 900 can be used by the RND System to define who the customer is and who is involved with this particular customer.

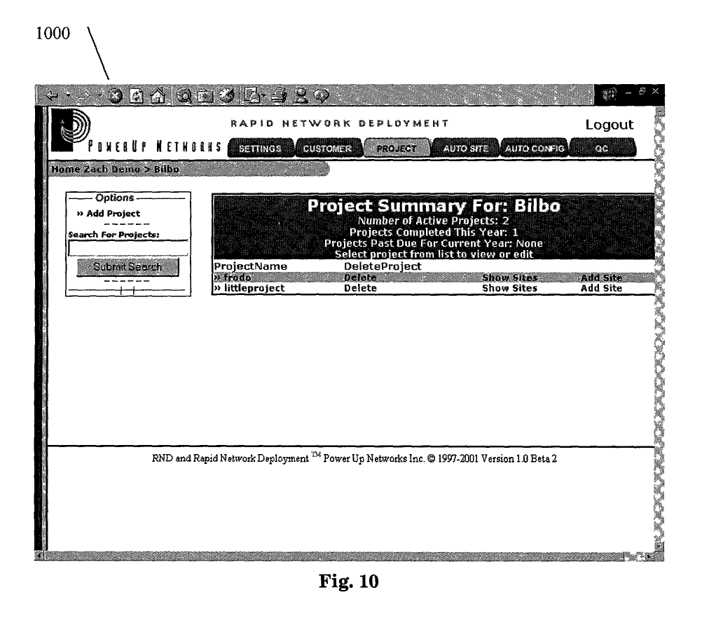

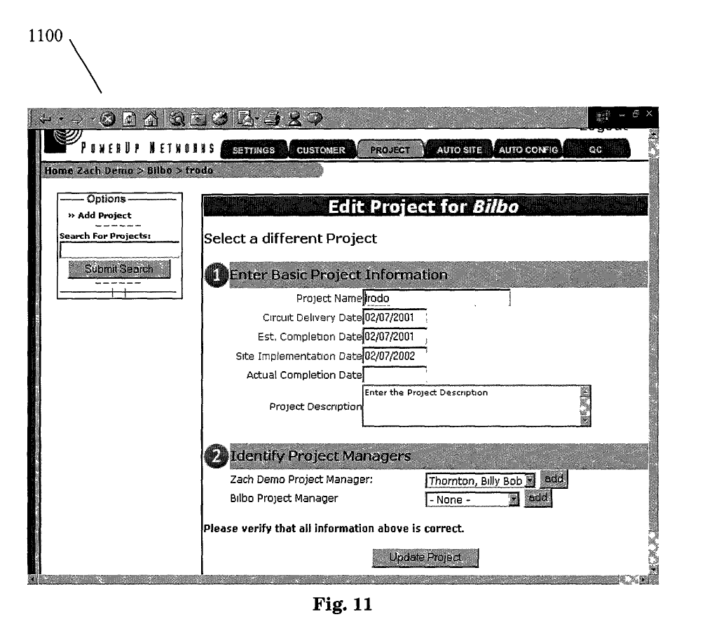

Referring to FIGS. 10 and 11, a project list panel 1000 and a project information panel 1100 are used for identifying basic project information and related personnel.

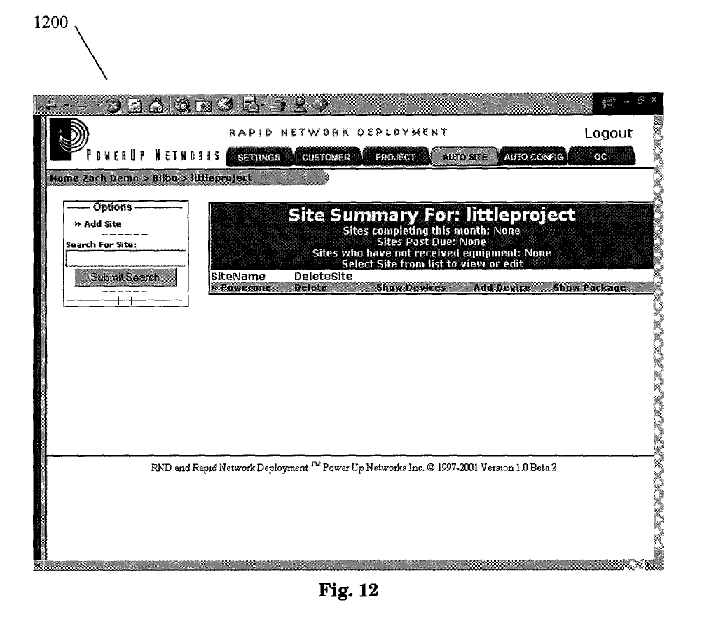

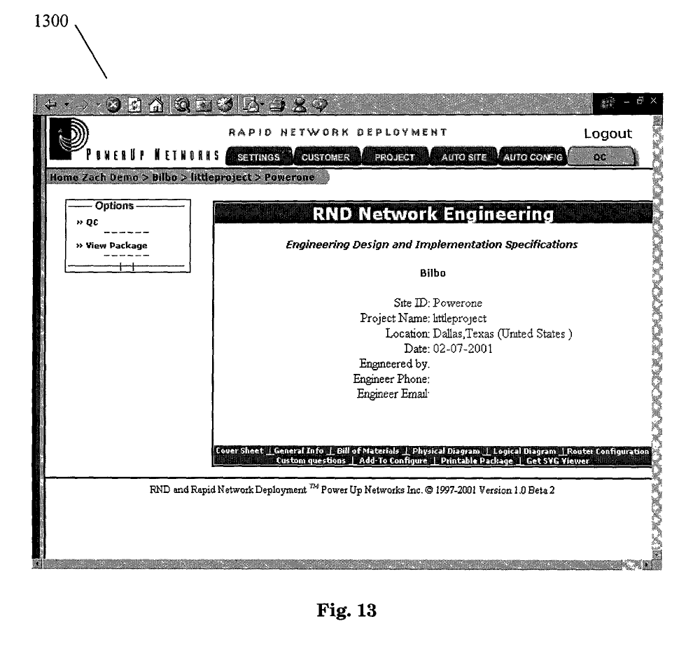

Referring to FIGS. 12 and 13, a site list panel 1200 and a site information panel 1300 provide information about projects going on in any site.

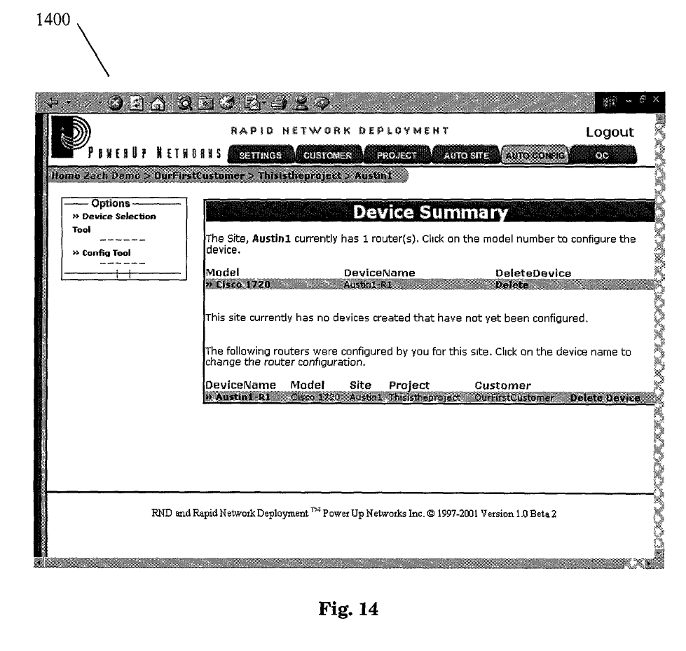

Referring to FIG. 14, a device list panel 1400 indicates to the engineer a specific telecommunication device existing at a particular site. The definition of each device includes information indicating which interfaces and sub-interfaces are to be installed and activated, and the automatic or user-specified assignment of unique identifiers such as IP addresses. For example, when a router is installed, all its selected network interfaces are determined to be activated in a predetermined sequence.

When a device is fully defined, specific information for each device (e.g., the Bill of Materials) can be retrieved from the web site of the device manufacturer or any other party who provide such information online, and copied into certain information defined and intended to be kept for the device.

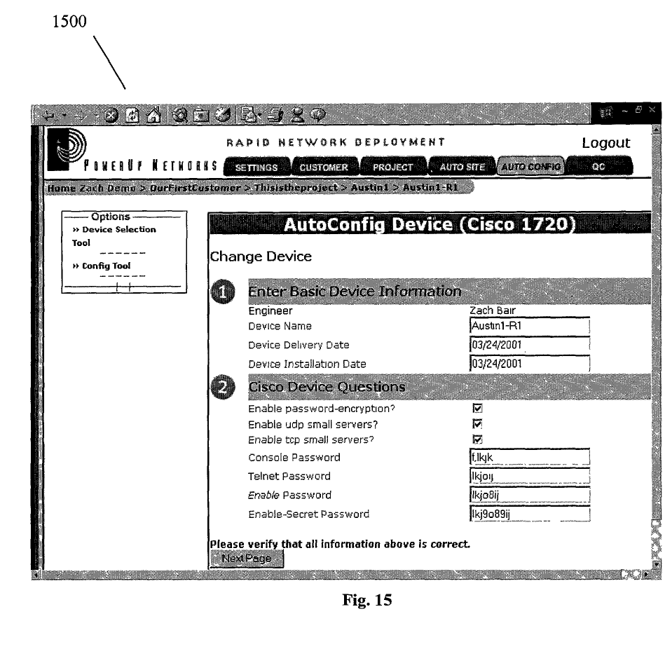

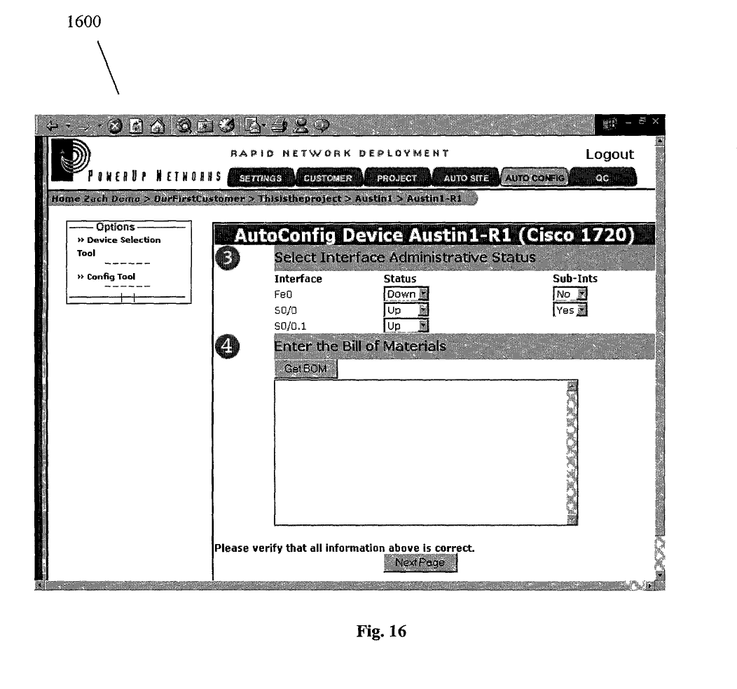

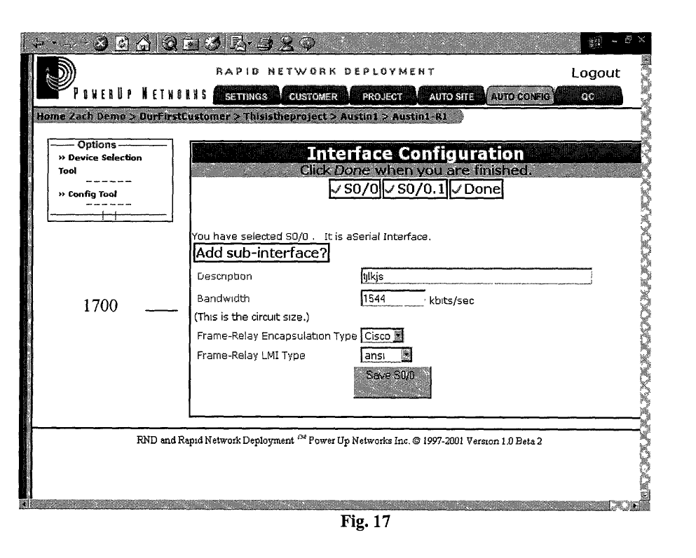

Referring now to FIGS. 15-17, by clicking on the device entry of the list, the device and its related sub-interfaces can be configured automatically.

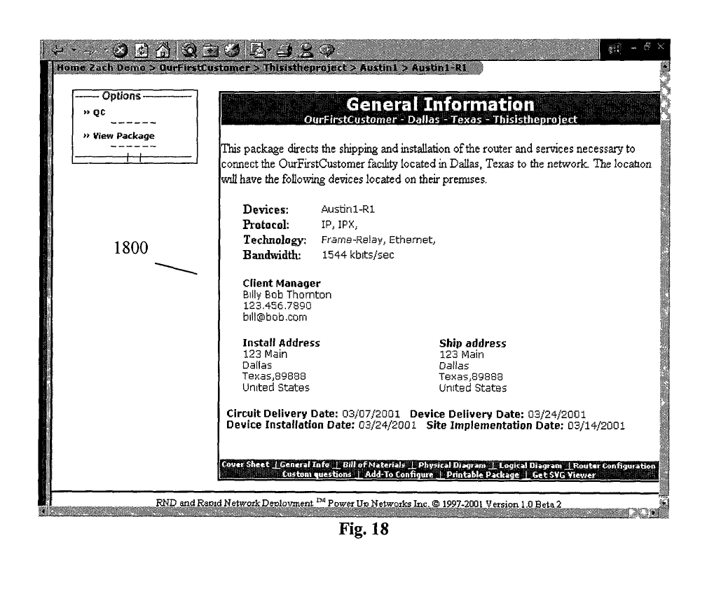

Referring to FIG. 18, a general information panel 1800 shows the engineer relevant information, such as where a device is, what technology the device uses, etc. After the information has been entered for all devices at a site, the device configuration information is generated upon a request of the engineer.

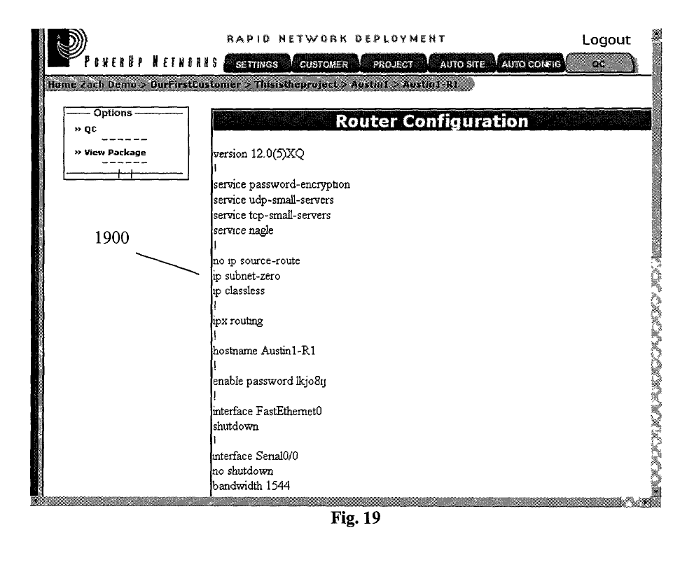

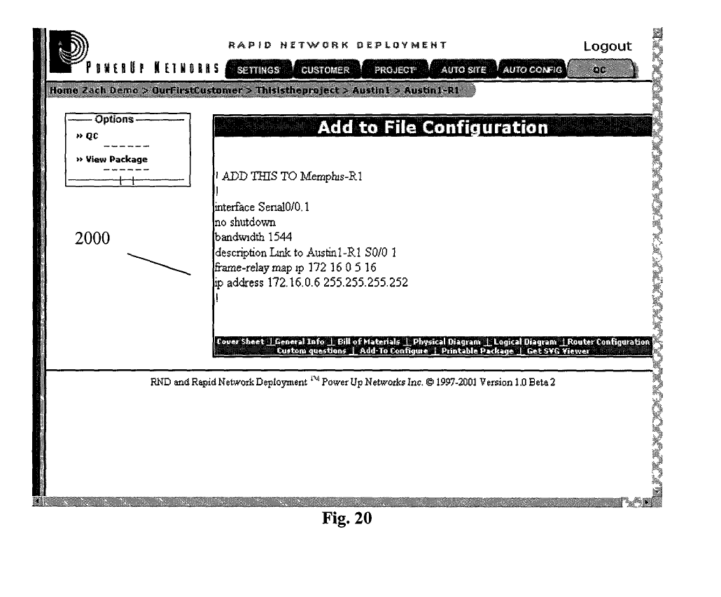

Referring to FIG. 19 a portion 1900 of such a configuration information is shown. The configuration information is in a format which can be directly loaded or entered into the device, or may be copied and pasted as text into appropriate documents or files. It is commonly referred to as a configuration file. If the configuration of the devices has been changed, the changed portion is also produced and available to add to existing configuration files. For example, when a site is added, the configuration files for the connected sites would change to reflect the newly included site. FIG. 20 illustrates a portion 2000 of a configuration file that can be added to an existing configuration file.

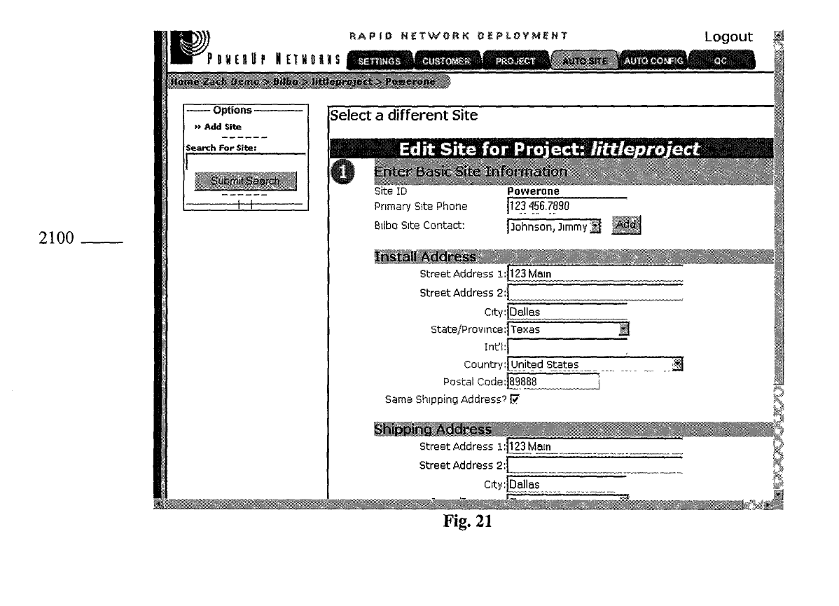

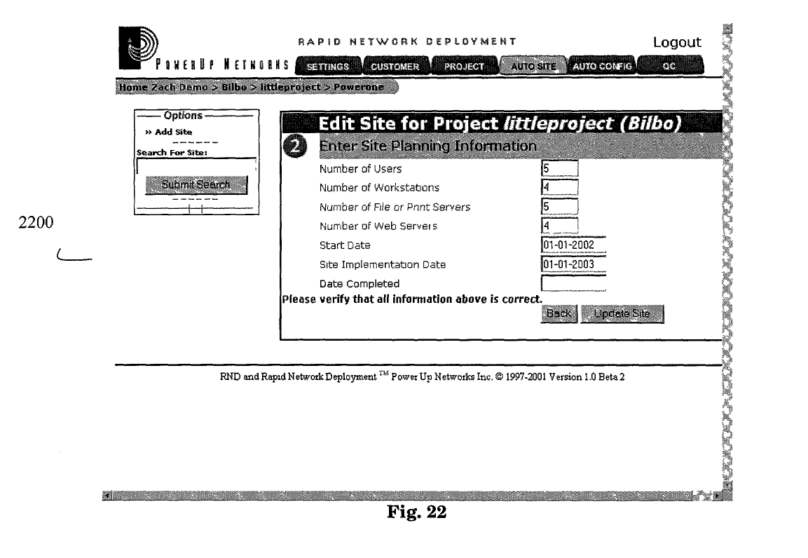

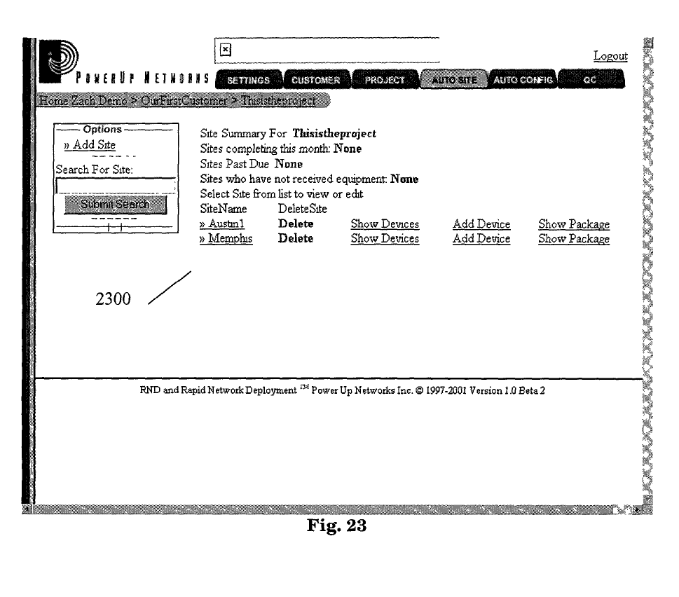

At each of the above steps, the engineer may request to search for one or more clients, customers, projects, sites, or devices matching entered criteria. A list of entities matching the criteria is shown, from which the engineer may select to review or change the properties or attributes, or may delete one or more found entities. For example, FIGS. 21-23 illustrate a set of panels 2100, 2200, 2300 for editing a site information. At each level, standard information may be copied from the settings entered as location defaults, application defaults, or other unique or customized information. The engineer may accept these defaults or enter new values.

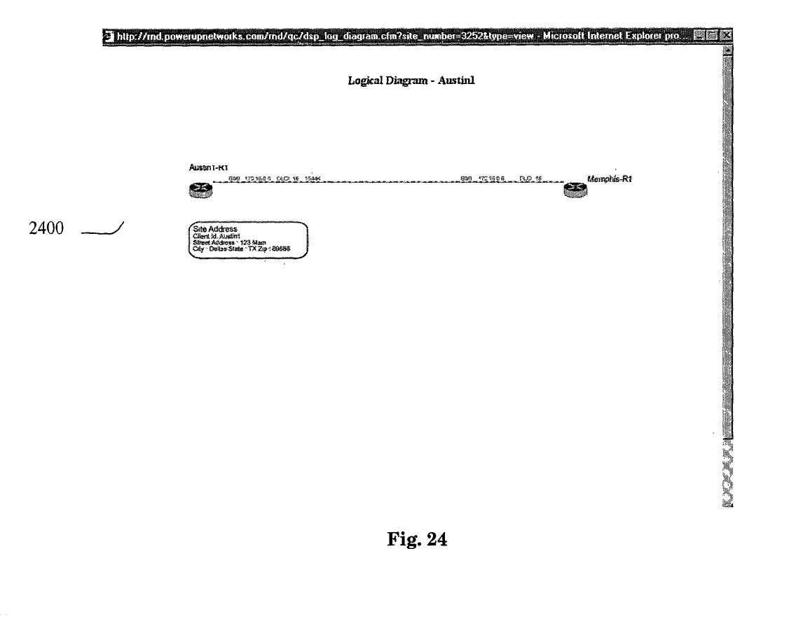

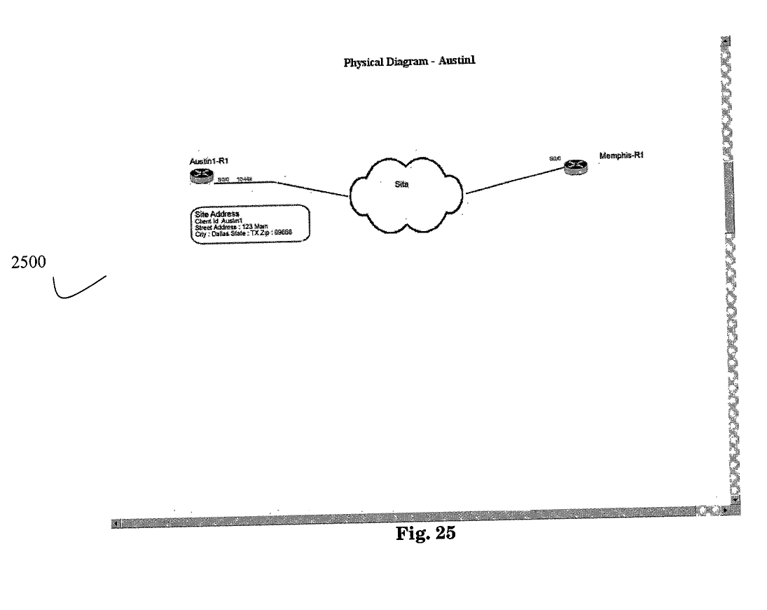

Finally, the engineering design and implementation specifications document may be reviewed and printed for each site. They can also be presented graphically as a logic diagram or a physical layout. In one example, such a graphical diagram uses scalable vector graphics for the diagram which allows an update in a real time fashion if the configuration of the network device is modified. Referring to FIG. 24, a logical diagram 2400 is shown for a router 2402 and its connection to another router 2404. FIG. 25 illustrates the physical diagram of the devices in FIG. 24.

The above disclosure may provide many different embodiments, or examples, for implementing different features of the invention. Specific examples of components, and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention, as set forth in the following claims.

1. A method for automating network deployment processes using a web-centric automation toolset for one or more users, each user having one or more customers, the method comprising:
administering one or more projects of each customer by collecting and presenting information of each project, each project involving deploying at least one network device at one site;
providing site configuration information for each project by collecting and presenting site planning information and site deployment information for each site; and
configuring each network device for each site based on the collected site planning information and site deployment information,
wherein the above steps are performed with the assistance of the web-centric automation toolset stored in a central location, and wherein one or more configuration files are generated and further transferred for use on the network devices.

2. The method of claim 1 further comprising confirming the configuration with the user before the one or more configuration files are transferred to the network devices.

3. The method of claim 1 wherein the network devices are routers.

4. The method of claim 1 wherein the step of administering further includes requesting and receiving project information through a user interface of the toolset.

5. The method of claim 1 wherein the step of administering further includes generating a network summary for each project.

6. The method of claim 1 wherein the step of configuring further includes:
selecting at least one network device;
customizing one or more communication interfaces;
providing basic device configuration information;
determining one or more communication interfaces to be activated; and
collecting information for bill of materials for the network device.

7. The method of claim 6 further includes identifying one or more subinterfaces to be activated that are connected to the network device.

8. The method of claim 6 wherein the step of collecting further includes connecting to an information provider who provides the information for bill of materials through a communication link.

9. The method of claim 1 further comprising presenting a physical diagram reflecting physical connections for the network device.

10. The method of claim 1 further comprising presenting a logical diagram reflecting a logical aspect of the network device.

11. The method of claim 1 further comprising using scalable vector graphics for all graphical presentations needed which allows an update in a real time fashion if the configuration of the network device is modified.

12. The method of claim 1 wherein the configuration file of a network device is updated if the configuration file of another network device connected thereto is changed.

13. A method for automating router deployment processes using a web-centric automation toolset for one or more users, each user having one or more customers and each customer having one or more projects, the method comprising:
providing a site configuration information for each project of a customer by collecting and presenting site planning information and site deployment information for installing at least one router at a selected site;
configuring automatically the router installed at the selected site based on the collected site planning information and deployment information; and
generating a router configuration file to be used on the router.

14. The method of claim 13 further comprising transferring the generated router configuration file to the router.

15. The method of claim 14 further comprising confirming the configuration before the router configuration file is transferred to the router.

16. The method of claim 13 wherein the step of providing further includes requesting and collecting network deployment information for the project through the web-centric automation toolset.

17. The method of claim 13 wherein the step of configuring further includes:
selecting at least one router;
customizing one or more communication interfaces of the router;
providing basic router configuration information;
determining one or more communication interfaces to be activated; and
collecting information for bill of materials for the router.

18. The method of claim 17 further includes identifying one or more subinterfaces to be activated that are connected to the router.

19. The method of claim 17 wherein the step of collecting further includes connecting to an independent information provider who provides the information for bill of materials through a communication link.

20. The method of claim 13 further comprising presenting a network diagram reflecting network connections for the router.

21. The method of claim 20 further includes using scalable vector graphics for the diagram which allows an update in a real time fashion if the configuration of the router is modified.

22. The method of claim 13 wherein the router configuration file is updated if configurations of other network devices connected to the router has been changed.
